(19) United States
(12) Patent Application Publication
(10) Pub. No.: US 2017/0159836 A1
(43) Pub. Date: Jun. 8, 2017

(54) SAFETY VALVE FOR WATER HEATERS

(71) Applicant: Thor Frolich BRAATHEN, Eggedal (NO)

(72) Inventor: Thor Frölich BRAATHEN, Eggedal (NO)

(21) Appl. No.: 15/327,082

(22) PCT Filed: Aug. 21, 2015
(86) PCT No.: PCT/NO2015/050141

§ 371 Date: Jan. 18, 2017

(30) Foreign Application Priority Data
Aug. 22, 2014 (NO) 20141033

(51) Int. Cl. F16K 17/04; F24H 9/20; F16K 41/10

(52) U.S. Cl. CPC F16K 17/0486; F16K 41/103; F24H 9/2007

(57) ABSTRACT

A safety valve comprising a valve housing (8) with an inlet and an outlet and a membrane gasket (7) to seal off the fluid connection between said inlet and said outlet. The membrane gasket (7) is adjustably influenced to cushioned closure of the connection against a seat (21) in the inlet. An upper part (20) comprises a stem housing (4), having a stem (1) to which the membrane gasket (7) is connected, a spring (2) acting towards the stem. A control wheel (5), adapted to pull the stem out of the valve seat (21), is connected to the valve housing (8). The spring housing (4) has an integrated buffer (3) with the same internal diameter as the spring housing (4). The buffer (3) and the spring housing forms a continuous guide for the spring (2) and stem (1), and said buffer (3) has a lower surface adapted to form a contact surface for the membrane gasket (7) when the valve is in the fully open position. Also disclosed is a click-fixation for the assembling of the wheel to the stem.

The present invention relates to a safety valve for water heaters and heating plants for houses and more specifically to an improved safety valve as specified in the preamble of claim 1.

As the name implies, the safety valve shall prevent the build-up of excessive pressure in the tank by opening at a predetermined pressure and release water. When the pressure is again below the valve opening pressure, the valve will close again by itself.

As described in the applicant's previous Norwegian patent NO161281, a combined safety valve and drain valve is used. Drainage is provided by turning a control wheel that in turn lifts a valve stem. The wheel can be locked in the draining position by interaction with bosses in the stem housing. When the draining is finished, the wheel is turned out of this position and the valve is again functioning as a safety valve.

Other examples of prior art are:

GB 1321147, which shows a valve equipped with a control wheel. The wheel has been fixed to the valve stem by clicking the wheel onto a conical head of the valve stem. To this end, the wheel has claws that will bend outwards when the wheel is pressed over the head of the valve stem and grip the head at its underside when the claws have been brought past the head.

EP 1816378, which shows a safety valve with a valve body made of plastic. A metal tubular connection is provided at the inlet opening of the valve body. An inwardly facing end of the tubular forms a seat for a valve plug.

NZ 328798, which shows a tap handle and spindle with a torque clutch. When a predetermined torque is exceeded, the resilient teeth of the torque clutch will give way and the clutch will slip.

According to the regulations that recently came into force, for instance a requirement for vapour test by an opening pressure at 10 bar, which gives 180 degrees steam, has been introduced. In addition, a great deal of details of the present solution that may work better has been revealed.

The applicant is also the proprietor of Norwegian patent 310988. This patent discloses a safety valve with a housing made of plastic. Unfortunately, it turned out that the market was not ready for safety valves made partially of plastic materials at this time and the valve according to the latter patent was therefore not marketed. Views on plastic materials and the quality of the plastic materials have changed significantly since then.

The present invention is therefore aimed at improvements of the applicants own solutions, as described in Norwegian Patent no. NO161281 and NO 310988, as well as the other know solutions described above.

Although, the safety valves described in the applicant's own above-mentioned patents works well in general, things can be made easier, the mounting can be performed faster, and the valve can work even better.

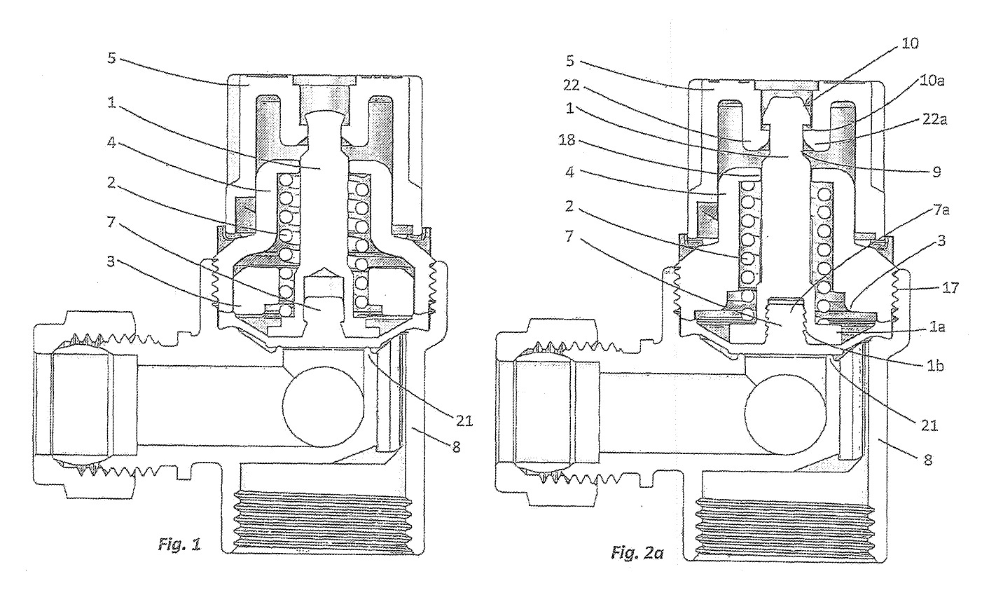

Before the improvement potential of the current solutions will be explained, the construction and assembly of the valve according to NO 161281 are explained using FIG. 1.

FIG. 1 shows the current solution with a stem made of brass material, a spring 2 made of steel and a buffer 3. These are assembled in sequence by threading the spring and buffer onto the stem: The stem 1 is then threaded through a hole in a spring housing 4 and a control wheel 5 is threaded onto the stem 1. The stem 1 bears against a steady surface and the wheel is pushed down so that the spring is compressed. Since the stem now extends out of the spring housing is it possible to rivet the upper end of the stem. The upper end of the stem is thereby expanded and the stem is fixedly connected to the wheel. A membrane 7 with its pin is then screwed into a threaded hole in the stem 1. After all these operations, a complete upper part, with its six sections can be fitted into a brass housing 8. According to NO310988, the housing 8 could alternatively be made of plastic.

Brass, which today almost controls the marked for this type of valves, has in spite of this, some significant drawbacks. Brass is highly susceptible to calcareous/lime deposits. Calcareous are found in virtually all water and will, over time, build up in the valve parts. Brass and other metals are here particularly exposed to this build up.

Experience has also shown that the riveting of the brass stem to the wheel, (as will be explained below) may produce metal shavings. These may find their way to the membrane and damage it so that the valve is leaking.

Experience has also shown that necessary clearance externally and internally of the buffer 3 results in poor control of the stem 1, this causes the membrane to open on only over a part of the diameter of the seat 21 of the housing 8. This may, for contaminated water containing grain of sand or other particles, induce notches in the seat 21. Thereby, the valve can leak.

A further problem that the present invention aims to solve is that when the valve is in the position where it is fully open and having a persistent opening pressure (a vapour pressure of 50 bar), which is nearly equal to the valve pre-tension pressure, the membrane will tend to knock continuously. This will quickly wear out the membrane and it will burst. If the buffer has a good contact surface for the membrane in the open position, this tendency is reduced and the lifespan can be increased considerably.

The present invention aims to avoid the abovementioned drawbacks. This is achieved by the features specified in the characterizing portion of the subsequent claim 1.

The present invention also aims at solving the problem with particle formation in the valve during assembly. This is solved by the features specified in the characterizing portion of the subsequent claim 2. By this solution, a quick and easy assembly is also achieved and where the user is unable to disassemble the wheel without destroying the valve.

An advantageous embodiment is defined in the dependent claim 3.

In the following, an advantageous embodiment of the safety valve according to the invention will be described in detail with reference to the drawings, in which:

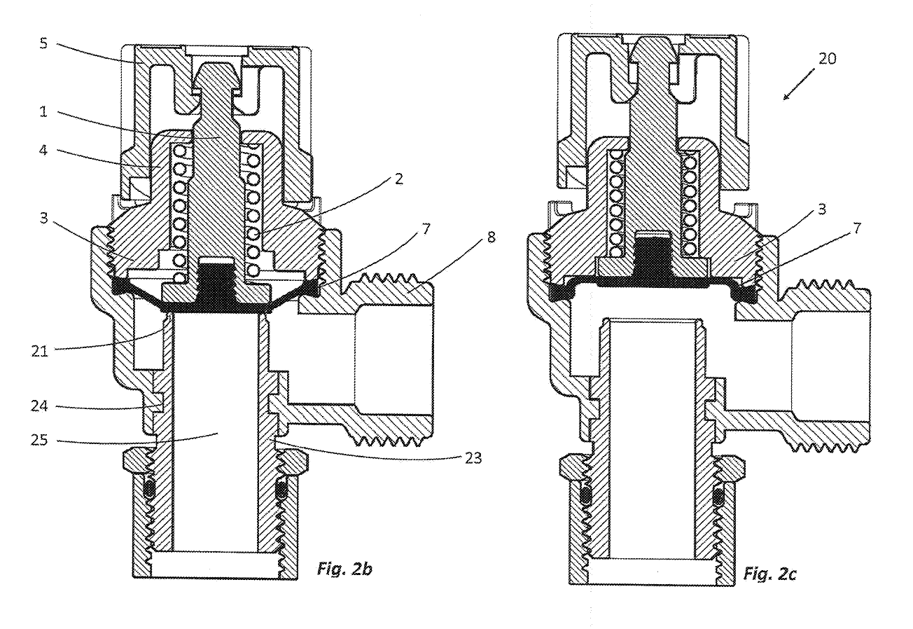

FIG. 2a shows a longitudinal section through an improved safety valve according to the invention.

FIG. 2b shows a longitudinal section through an improved safety valve according to an alternative embodiment.

FIG. 2c shows a longitudinal section through the valve of FIG. 2b, but in open position.

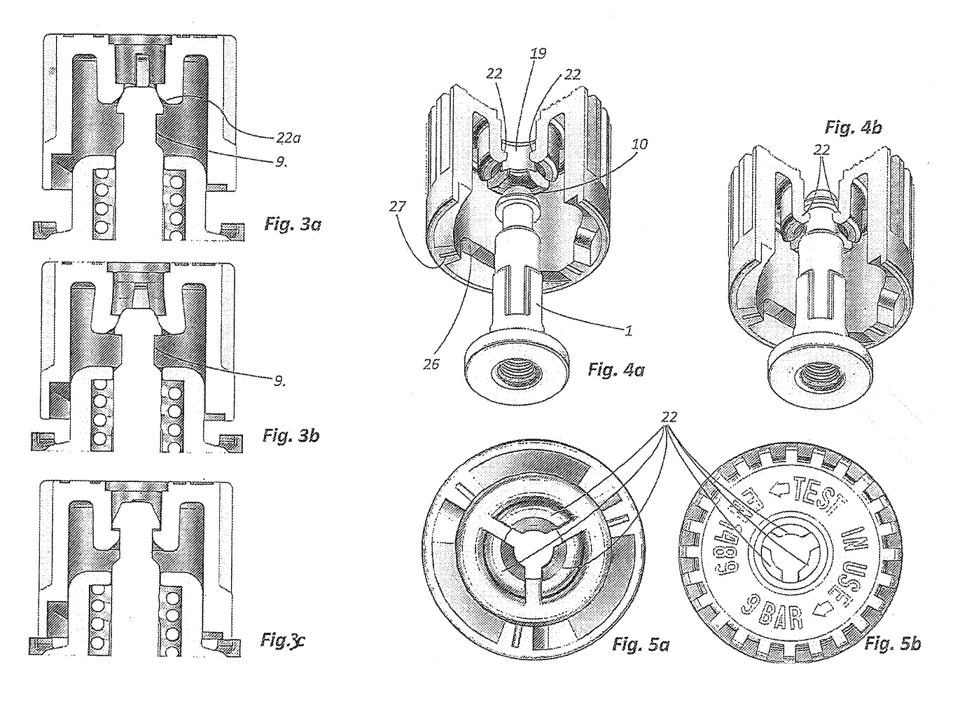

FIGS. 3a-3c show a click-on of the wheel on the stem in steps and in section.

FIGS. 4a and 4b show respectively the wheel and the stem, separately and interconnected.

FIGS. 5a and 5b shows the wheel shown from below and from above, respectively.

According to FIG. 2a, the valve comprises an upper part 20 and a housing 8. The housing may, as shown in FIG. 2a, be made of brass, but it can also be made of injection-moulded plastic, with a moulded-in pipe, as will be explained further below with reference to FIG. 2b.

The upper part comprises a stem 1, a spring 2, a spring housing 4 with integrated buffer 3, a wheel 5 and a membrane 7. Each of these parts, except for the spring 2 are made of plastic.

The spring housing 4 is designed with the buffer 3 integrated as a part of the spring housing. Thereby, there is a need for clearance in only one place, namely between the buffer 3 and the spring 2. The possibility that the stem 1 is set askew is therefore reduced. As shown in FIG. 2c the buffer 3 provides by its lower planar surface, a full support for the membrane 7 at its outer portion when it is exposed to full opening pressure.

The lower surface of the stem 1 and the lower surface of the buffer 3 are flush with each other and create a coherent surface in the fully open position of the valve. Thereby, the membrane will resist blow out by steam testing, which is used by EN (European Norm) tests for the approval of safety valves.

The spring housing 4 is screwed into a threaded portion 17 of the valve housing 8 and clamps thereby the outer edge of the membrane 7 between itself and the valve housing 8. The membrane is thereby locked and a seal is obtained between the valve housing 8 and the upper part 20.

The spring housing 4 also pushes the spring together towards the membrane 7 and a valve seat 21 in the valve housing 8, so that the spring 2 obtains a proper pre-tensioning force, this force could for instance be 8-10 bar.

The stem 1 comprises a head la which provides full support to the membrane 7 against the seat 21. The head 1a has a blind hole 1b with internal threads or grooves which are adapted to hold a journal 7a on the membrane 7. The journal 7a may either be screwed or pushed into the hole 1b. The stem thereby maintains the membrane 7 in the centre, and the membrane 7 thereby follows the stem 1 upwardly when the wheel 5 is activated and pulls the stem 1 upwards. This feature is per se known from NO161281.

The stem 1 has, at the upper end, a conical shape 10 with a shoulder 10a. Beneath the shoulder 10a, the stem 1 has a section 9 with a smaller diameter.

Beneath the section 9, the stem has a diameter substantially equal to the diameter of an opening 18 in the spring housing 4. Next to the head 1a, the stem has a diameter substantially equal to the inner diameter of the spring 2.

The spring housing 4 has an inner diameter substantially equal to the outer diameter of the spring 2.

The guiding of the stem in the opening 18 and the long guiding distance in the spring housing 4, gives a substantially perfect guiding in the centreline of the membrane 7 for a spring pressure that pushes the membrane 7 with substantially equal pressure around the whole diameter of the seat 21 and gives substantially equal opening by the opening pressure around the whole diameter.

The procedure for assembly of the upper part 20 will be described in the following.

The spring 2 is threaded onto the stem 1 from the end with the conical shape 10. The spring 2 and the stem 1 are then inserted into the spring housing 4 and the stem is threaded through the opening 18.

The membrane 7 is then inserted in a jig (not shown), the jig has an opening, which corresponds with the outer diameter of the spring housing 4, and a planar bottom. The spring housing 4 together with the stem 1 and the spring 2 are then inserted downwards into the jig.

Above this assembly there is arranged a hydraulic pressing device. The wheel is retained in this. The pressure device forces the wheel 5 down towards the spring housing 4 and the stem 1. The wheel 5 impinges the spring housing 4 by features not shown and pushes this down. The spring 2 is thereby compressed and the stem 1 with its conical shape 10 is pushed out of the opening 18. By the same operation, the journal 7a of the membrane 7 is pushed into the hole 1b in the stem 1.

As shown in FIGS. 4a and 5a, the wheel 5 has a centre opening 19, surrounded by a number of grapplers in the shape of claws 22, in this case three. The wheel with the claws 22 is made of plastic. The claws 22 are thereby resilient. When the wheel 5 is pushed down onto the conical shape 10 of the stem, the conical shape 10 is pushed through the opening 19 and pushes the claws 22 outwardly, as shown in the FIGS. 3a and 3b. The claws 22 have an inclined surface 22a against the stem 10. This makes it easier for the stem to enter. After the conical shape 10 has got past the claws 22, the claws 22 slip back and grab the shoulder 10a. The wheel cannot now move outwardly (upwardly in the figure) in relation to the stem. The plastic material and the shape is adapted so that the claws 22 only undergo an elastic deformation.

The upper section is now ready to be threaded into the valve housing 8. When these two parts are assembled together, the spring 2 will be provided with the correct pre-tensioning, and thereby correct opening pressure. When the valve opens due to overpressure, the membrane 7 and the stem 1 are pushed upwardly. Since the stem has a section 9 beneath the shoulder 10a, which has a diameter corresponding to the clearance between the claws 22, the stem is allowed to glide upwardly in the opening 19 in the wheel 5. This means that the wheel is not required to follow this movement. It is therefore impossible to block the safety valve for instance by putting a heavy load on top of the wheel. It is also impossible for the user to manipulate the opening pressure of the valve. A turn of the wheel will only result in an opening of the valve. The wheel has cams 26 situated at the inside, co-operating with bosses on the spring housing. Thereby the wheel is pulled outwardly and pulls the stem along with it. Notches 27 arranged at the top of the cams ensures that the wheel is put in a position where the valve is open. If the wheel is turned in either way from this position, this result in the wheel being pulled towards the spring housing again. This function is also used in the solution described in NO161281. It is thereby impossible for the user to manipulate the opening pressure of the safety valve.

In FIG. 2b another embodiment of the invention is shown. This comprises a valve housing 8 made of plastic, for instance PPS, which can withstand 240° C. for a long time. There is a pipe of metal 23 moulded-in at the inside of the plastic housing 8. The pipeline 23 having a part 24 with longitudinal and transverse grooves arranged to provide a good grip in the plastic. A bore 25 leads the pressure water towards a seat 21, against which the membrane 7 is adapted to seal. The moulded-in pipe 23 preferably consists of a non-magnetic material especially hardened for a longer possible lifetime of the seat 21. It will also prevent calcareous deposit.

The present invention achieves also the following additional advantages:
The plastic stem has less friction than brass.
It is possible simply to click the wheel on the stem instead of riveting.
Thereby, the overall upper part is click-assembled in seconds.
As the riveting is avoided, there will be no metal shavings, which may contaminate the membrane and the seat.
By eliminating a loose buffer and integrate this in the spring housing, the upper part is thereby reduced to only five parts compared to the current six parts. An additional time during assembly, is thereby saved.
The integrated buffer causing the guiding path for the spring to be significantly prolonged and guiding of the stem and membrane is therefore better.
By replacing the valve housing made of brass with a housing made of plastic with an embedded pipe of a non-magnetic hardened material, a considerably longer lifetime for the valve seat is achieved.
Simultaneously, all the incoming pressure is taken up in the bore of the pipe without exposing the plastic housing to this pressure. The plastic housing will only absorb water that has passed the membrane and therefore do not have any significant pressure.
Since the pipeline is made of a non-magnetic material and the housing is made of plastic, which is neutral in the galvanic series, calcium will not adhere on the pipe in the same manner as brass, which has a strong positive galvanic series, and where the calcium is negative, will over time adhere and hence over time reduce the diameter.
A stem of plastic, instead of brass, causes reduced expenses. The same applies to the valve housing which is now substantially made of plastic.
A fewer number of parts and easier assembly reduces the cycle time significantly. The end-user gets in general a valve that is substantially less expensive and has a longer lifetime.

1. A safety valve comprising a valve housing with an inlet and an outlet and a membrane gasket to seal off the fluid connection between said inlet and said outlet, said membrane gasket is adjustably influenced to cushioned closure of the connection, against a seat in the inlet, where an upper part, comprising a stem housing, having a stem to which the membrane gasket is connected, a spring acting towards the stem, and a control wheel adapted to pull the stem away from the valve seat, is connected to the valve housing, wherein the spring housing has an integrated buffer with the same inner diameter as the spring housing, and that the buffer and the spring housing form a continuous guiding of the spring and stem, said buffer having a lower surface adapted to form a contact surface for the membrane gasket when the valve is in fully open position.

2. A safety valve comprising a valve housing with an inlet and an outlet and a membrane gasket to seal off the fluid connection between said inlet and said outlet, said membrane gasket is adjustably influenced to cushioned closure of the connection, against a seat in the inlet, where an upper part, comprising a stem housing, having a stem to which the membrane gasket is connected, a spring acting towards the stem, and a control wheel adapted to pull the stem away from the valve seat, is connected to the valve housing, wherein the stem is made of plastic and has a click-fixation for coupling to the wheel, that the stem has a conical shape at the end facing away from the membrane gasket, said shape having a shoulder facing towards said membrane gasket, that the wheel comprises a number of claws adapted to grip the conical shape and abut the shoulder and that the stem has a section from the shoulder in the direction towards the membrane gasket, said section having a diameter substantially equal to the clearance between the claws.

3. The safety valve according to claim 2, wherein the claws have a conical surface facing the conical shape of the stem.
